(19) United States
(12) Patent Application Publication
(10) Pub. No.: US 2026/0073546 A1
(43) Pub. Date: Mar. 12, 2026

(54) AUTOMATED EYEWEAR MEASUREMENT SYSTEM USING ARTIFICIAL INTELLIGENCE

(71) Applicant: ACEP FRANCE, Paris (FR)

(72) Inventors: Jean Philippe SAYAG, Paris (FR); Adrian Sergiu Darabant, Cluj Napoca (RO); Diana Laura Borza, Cluj Napoca (RO); Tudor Alexandru Ileni, Unirea (mun. Bistrita) (RO); Alexandru Ion Marinescu, Cluj-Napoca (RO)

(73) Assignee: ACEP FRANCE, Paris (FR)

(21) Appl. No.: 19/324,792

(22) Filed: Sep. 10, 2025

Related U.S. Application Data
(60) Provisional application No. 63/692,859, filed on Sep. 10, 2024.

(51) Int. Cl. G06T 7/60; G06T 7/12

(52) U.S. Cl. CPC G06T 7/60; G06T 7/12; G06T 2207/10012; G06T 2207/10028; G06T 2207/10048; G06T 2207/20081; G06T 2207/30201; G06T 2207/30204

(57) ABSTRACT

According to one or more embodiments, an automated system for performing precise eyewear measurements necessary for the fitting and manufacturing of corrective eyewear may be provided. The automated system may enable the measurement of interpupillary distances for distance and near vision, pupillary heights, reading distance, pantoscopic tilt, vertex distance, and frame curvature. These measurements may ensure that the corrective lenses are centered and adjusted to the visual needs of the wearer.

### BACKGROUND

The optical industry is currently facing a shortage of qualified opticians worldwide, resulting in a lack of skilled labor to perform critical tasks such as the accurate measurement of optical parameters. The precision of a pair of prescription glasses depends not only on the quality of the corrective lenses but also, and perhaps more importantly, on the accuracy of these measurements. Inaccurate measurements can lead to poor fitting, discomfort, and even the need for adaptation requests, particularly with progressive lenses.

Some methods for obtaining these measurements involve specialized training and/or manual intervention by an optician, who places markers on the eyewear and uses a computing device, such as a tablet, to capture images, and then manually adjusts these images to ensure measurement accuracy. However, some methods can be influenced by human factors, such as the unnatural posture of the eyewear wearer or parallax errors and may not always be performed accurately by less experienced personnel.

### SUMMARY

According to one or more embodiments an automated system for performing precise eyewear measurements necessary for the fitting and manufacturing of corrective eyewear may be provided. The automated system may enable the measurement of interpupillary distances for distance and near vision, pupillary heights, reading distance, pantoscopic tilt, vertex distance, and frame curvature. These measurements may ensure that the corrective lenses are centered and adjusted to the visual needs of the wearer.

The automated system may be assisted by artificial intelligence (AI), which may be trained on large image datasets. The AI may automatically detect the reference markers, corneal reflections or eye glint, and the contours of the eyewear frame on the captured images, eliminating the need for manual intervention and specialized training. This automation may aid individuals without formal training in optometry to better perform precise eyewear measurements. The automated system may be implemented in software or use neural networks that allow steps after the manual capturing of images to be partially or fully automated.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1A is a system for generating automated eyewear measurements according to an exemplary embodiment;

FIG. 1B is another system for generating automated eyewear measurements according to a different exemplary embodiment;

FIG. 2 is a Frame Reference Device (FRED) according to an exemplary embodiment; and

FIG. 3 is a method for generating automated eyewear measurements according to an exemplary embodiment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation. Further, aspects of one embodiment described herein may be combined with aspects of different embodiments described herein.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptrons (MLPs), Support Vector Machines (SVMs), Recurrent Neural Networks (RNNs), Convolutional Neural Networks (CNNs), Large Language Models (LLMs), transformers, decision trees, random forests, gradient boosting, nearest neighbor models, clustering algorithms, expert systems, mixture of experts models, ensemble models, diffusion models, reinforcement learning, and autoencoder models, to name a few. However, many other forms of AI and ML architectures that enable the processor to perform the same functionality alternatively may be used. Moreover, functions described herein may be performed serially or in parallel, such as the calculation of outputs from a weighted series of connections that receive the inputs to the system. Such functions may be performed by one or more threads or cores and on architectures that otherwise support parallelism (such as Single Instruction, Multiple Data (SIMD) architectures) and on Graphics Processing Units (GPUs).

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

As used herein “eyewear measurements” may be understood to mean the dimensions of a pair of glasses or glasses frames such that the glasses or glasses frames fit the face of a user, are centered, and/or are adjusted to the visual needs of the wearer.

In one or more exemplary embodiments an automated system for performing precise eyewear measurements for the fitting and manufacturing of corrective eyewear may be provided.

According to an exemplary embodiment, the automated system for taking eyewear measurements may include an image capturing device that may take a series of images of a user from one or more different perspectives or angles. The system may further include a marking device applied to the eyewear frame of the user, which may include at least three predetermined reference points. A pre-trained artificial intelligence (AI) system may be included to automatically analyze images to detect the reference points, corneal reflections, and frame contours, and to calculate eyewear measurements, including but not limited to, interpupillary distances for distance and near vision, pupillary heights, pantoscopic tilt, vertex distance, reading distance, and frame curvature.

In at least one embodiment the artificial intelligence may automatically correct parallax errors and optimize the posture of the eyewear wearer during the measurement process. The artificial intelligence may further be capable of continuously learning from newly captured images to improve the accuracy of the eyewear measurements. This may occur, for example, by having trained personnel analyze the output of the artificial intelligence to correct any errors. The manual correction may occur at the time that a user is being fitted for glasses or it may be performed separately to assist with the improvement of the artificial intelligence.

In some embodiments the automated system may further include a communication module that may transmit the calculated eyewear measurements to an external device for further analysis or to trigger a subsequent action, such as automated creation of the eyewear having the determined measurements. The system may also include an audio guidance module which may provide step-by-step instructions to the eyewear wearer, facilitating a fully automated measurement process. In some other embodiments one or more light sources may be used to create corneal reflections or enhance the detection of the reference points and frame contours during the image capturing process.

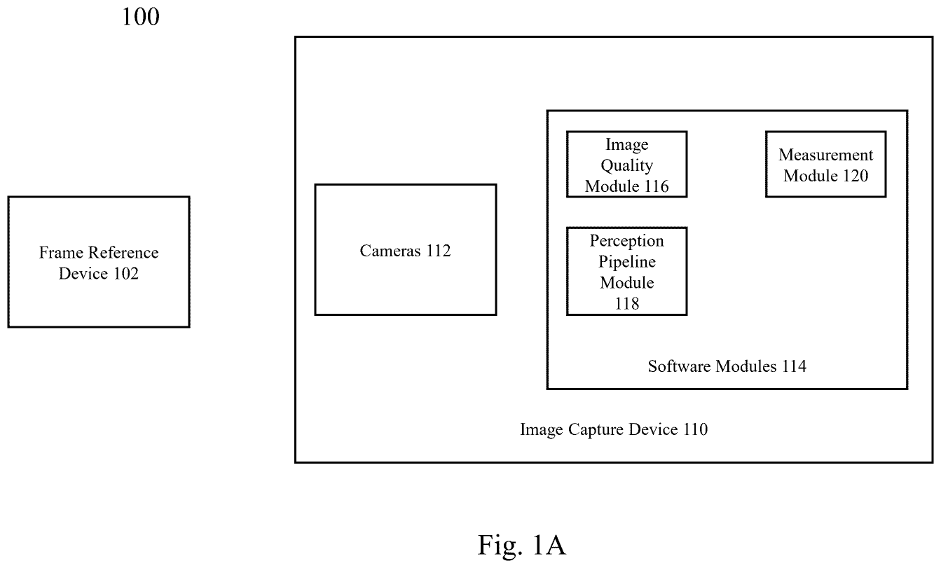

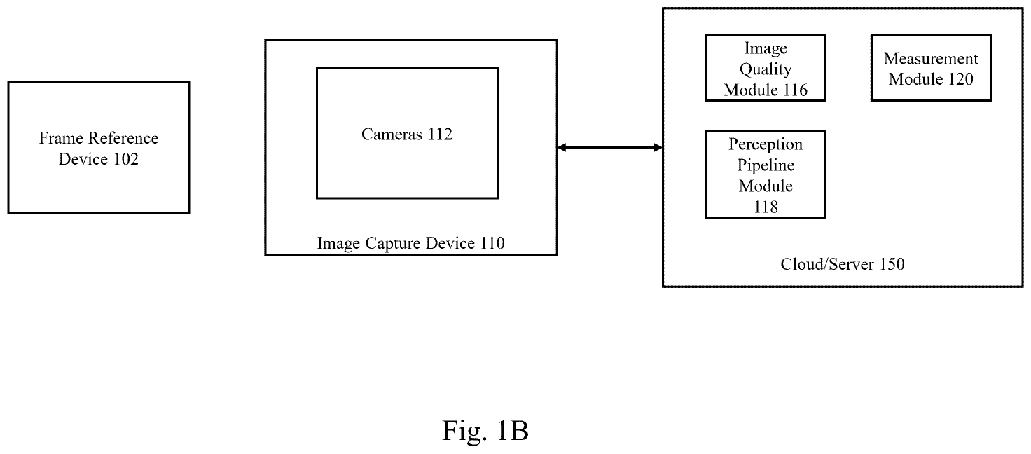

Referring now to FIGS. 1A-1B, exemplary systems for generating automated eyewear measurements 100 may be shown and described. The exemplary system may include a Frame REference Device (“FRED”) 102 which may be placed on eyewear of a user. In some embodiments the frame reference device may contain one or more reference markers whose arrangement and distances are known. The system may further contain an image capture device 110 which may be, for example but not limited to, a tablet, iPad, glasses with built in cameras, etc. The image capture device 110 may contain one or more cameras or other image capture devices 112. The image capture device 110 may further contain a plurality of software modules 114, for example an image quality module 116, a perception pipeline module 118, and/or a measurement module 120.

It may be understood that in some embodiments the cameras 112 may be built in to the image capture device 110, while in other embodiments the cameras 112 may be separate devices which communicate with the image capture device 110, e.g. through a wireless or cloud connection. Likewise, the one or more software modules 114 may be software programmed onto the image capture device 110 and run by processors and/or memory of the image capture device, or may be run separately, for example being contained on one or more separate server devices, on a cloud architecture 150, or on another user device. It may be understood that in these embodiments the image capture device may communicate captured images to, and/or obtain results from, the one or more software modules 114.

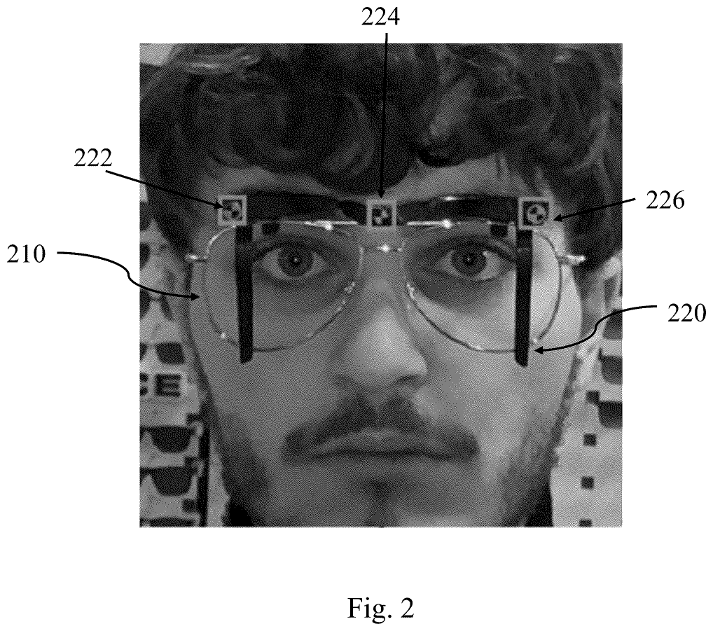

Referring to FIG. 2, an exemplary FRED device 220 may be shown and described. The FRED device 220 may be placed on eyewear 210. The FRED device 220 may have one or more known dimensions and/or one or more reference points, for example a left reference point 222, a central reference point 224, and a right reference point 226.

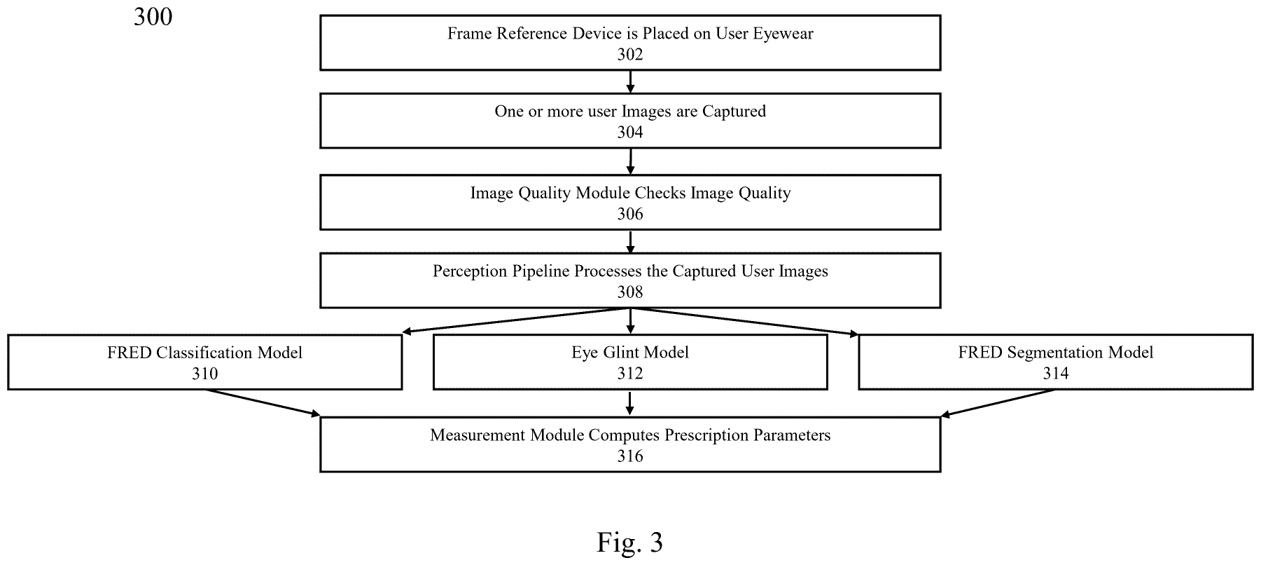

Referring to FIG. 3, an exemplary method for generating automated eyewear measurements 300 may be shown and described. In a first step 302 a FRED may be placed on eyeglasses or eyewear of a user. In a second step 304 one or more images of the user may be captured via an image capturing device. In a third step 306 an image quality module may check the one or more images for image quality. In a fourth step 308 a perception pipeline module may process the one or more captured images to obtain a plurality of parameters. According to at least some embodiments the perception pipeline module may include one or more sub-module processing steps, for example but not limited to processing through a FRED classification model 310, an eye glint model 212, and/or a FRED segmentation model 314. In a final step 316 a measurement moule may compute eyewear measurement parameters for eyewear based on the one or more parameters obtained by the pipeline module.

Referring generally to one or more exemplary embodiments, the steps for the fitting and manufacturing of corrective eyewear may now be described.

A first step may include a preparation step. In one embodiment, the preparation step includes equipping a eyewear wearer with a new frame, on which a FRED with a predetermined number of selectively positioned reference markers, e.g., three, may be placed. These markers may be selected such that they can serve as reference points from which scale and parallax may be determined.

In another embodiment, the preparation step may include the eyewear wearer performing one or more actions, such as turning their head from side to side. A benefit of performing such actions may be that it allows the eyewear wearer to align their head in a more natural position prior to any images being acquired. This embodiment may be implemented without a FRED being placed on a frame. The determination of scale and parallax may be determined by using a distance measurement method or apparatus. For example, distance between a computing device, e.g., an image capturing device, and the eyewear wearer may be determined using Lidar, Sonar, a 3D camera, TrueDepth, one or more lights with reflectors used to determine distance, or any other method of determining the distance between a computing device and a eyewear wearer that allows for the determination of distance. The distance determination method and/or apparatus may be selected such that it may determine scale and parallax either alone or in combination with other apparatus and/or methods described herein.

In one embodiment, a second step may include an image capturing step. In the image capturing step, the system may automatically capture a predetermined number of images (e.g., 2, 20, or even up to 1,000,000 images) of the eyewear wearer using the camera of an electronic device such as, for example, a tablet, iPad, or glasses with built in cameras, both for distance and near vision. In some embodiments the setup may include a plurality of image capturing devices, for example, a pair of stereo cameras, a combination of a LIDAR and a camera, etc. In other embodiments the image capturing device may be a tablet, smartphone, or any other device equipped with a camera, capable of operating autonomously or in a networked environment. The images may be taken from different angles or perspectives to capture as much relevant data as possible. In at least one embodiment the image capturing device may obtain a selected number of images ranging from, for example, between 10 to 1,000,000, allowing for increased accuracy through the application of statistical analysis to the eyewear measurements.

In some embodiments the image capturing step may include an image quality module, which may check the quality of some or all of the captured images and select a subset of the images with a best quality. In a first exemplary embodiment the image quality module may utilize outlier rejection to filter out errors or inconsistencies in base images caused by, for example, motion blur, blinks, or other single-frame errors. A statistical measure may then be applied to any remaining values in order to determine a final parameter set, for example taking a median of the cleaned dataset.

In a second exemplary embodiment a ML model may be utilized to determine a quality of each of the plurality of images, for example quality may be determined on a 0 to 1 scale. Quality may then be measured through, for example, the methodology described in the first exemplary embodiment above but with the scores being weighted based on the image quality determined by the ML model. In some embodiments scored below a certain value may be entirely discarded.

In a third exemplary embodiment a multimodal system may be utilized. The multimodal system may process and analyze one or more streams of data simultaneously. The streams of data may include, for example, visual information from video frames, initial numerical measurements calculated for each frame, and/or raw sensor data from the image capture device, such as tracking information, depth information, etc. The multimodal system may further include an ML model that determines a relationship between a plurality of datapoints within the one or more streams of data. For example, the model may automatically down-weight measurements from a frame where the tracking shows a sudden jitter, as this may correspond to a blurry image or unreliable glint detection. The system may further differentiate between momentary errors and measurement opportunity, such that the information is synthesized in order to generate a single-refined set of parameters, thereby correcting minor, systematic errors and producing accurate results.

A third step may include a perception pipeline module, which may automatically process data from the image capturing step in order to generate one or more eyewear measurement parameters. The perception pipeline may utilize one or more integrated AI which may analyze each image to identify and locate predetermined features, such as reference markers, corneal reflections, and the contours of the frame. The AI neural networks may be trained using images of subjects wearing glasses/frames. In an exemplary embodiment the perception pipeline may include a plurality of AI or ML model submodules, for example a FRED marker detection module, a FRED segmentation module, and an eye glint module. The AI Neural network may further estimate the age, gender, mask of hair over a user's face, race, etc in order to further specialize facial features. For example older people exhibit changed altered face geometry due to the skin not tensed over the facial bones. Also for women there is often hair covering important parts of the face, Asian people may have smaller bridge and nose depth, etc.

Explaining training of the models generally, datasets used for training of any of the models may undergo one or more augmentation processes, including but not limited to random crops; central crops; random horizontal flips; random rotations; random affine transformations; random changes to brightness, contrast, saturation, and/or hue of an input image; random grayscale conversion; random auto contrast; random erasure of image regions (CutOut augmentation); random (Gaussian) blurring of the image; randomly mixing two images by cutting a patch from one and pasting it into a second (CutMix augmentation); random perspective transformation; random elastic transformation; random color channel permutations; random Gaussian noise, random posterization; random image histogram equalization; RandAugment: practical automated data augmentation with a reduced search space; AutoAugment: learning augmentation strategies from data; and/or TrivialAugment: tuning-free yet state-of-the-art data augmentation.

The models may be trained on a plurality of images, these images may be synthetically generated and/or annotated with information about a plurality of features, for example: corneal reflections (or pupils), eyebrows, frame position and contour of lens, head positioning, position of reference markers on the Frame Reference Device, etc. In some embodiments images may be manually annotated by operators without storing any other personal information about them. In some embodiments a synthetically generated dataset (for example generated programmatically) of faces wearing the 3D model of the FRED and different types 3D models of glasses/frames. In some embodiments postprocessing may be applied using computer vision algorithms developed to refine the obtained data to be able to perform accurate geometrical computations on them.

For example, a first AI network may may a FRED marker detection module, which may precisely detect one or more FRED markers. In some exemplary embodiments the FRED marker detection network may utilize a course to fine analysis approach. In a first sub-step a trained ML may be utilized to quickly find a general location for each of a plurality of markers in a specified region on the image, for example the upper side of a face. In some embodiments this detection may be via, for example, a dedicated face detector, which may be understood to detect markers even in bad lighting and/or with cluttered backgrounds. In some embodiments the facial detector may be used only in certain circumstances, for example in images where the quality is low due to residual reflections, over or underexposure, etc. Once the general locations have been identified, in a second sub-step a fine-tuning ML may be applied which may refine marker locations to, for example, sub-pixel accuracy. In at least some embodiment the fine-tuning ML may utilize, for example, template matching or dense local search methods.

In some embodiments the specifics of the models utilized may be dependent on the devices performing the analysis. For example, there may be a plurality of models ranging from 2.6M parameters to 65.8M parameters, which may range from low end models to high end models. Depending on the operative device a specific model may either be pre-selected, or may be dynamically selected based on, for example, processing power. In some embodiments some lower parameter models may go through additional knowledge distillation training in order to mimic larger models and reduce loss in performance or accuracy while still being operable on lower end devices. For example, a smaller model of 2.6M parameters may go through an additional prediction training phase based on the results of the larger model (e.g. 65.8M parameters), for example through a supervised training phase with the larger model acting as the supervisor. The smaller model may thereby be trained to predict similar outputs as the larger model without substantially increasing the operating requirements of the model. In different embodiments several input resolutions of images may be utilized, for example 512×256 or 448×224. It may be appreciated the above numbers are purely illustrative and non-limiting, and that in other embodiments fewer than 2.6M or more than 65.8M parameters may be utilized. In some embodiments an image pyramid method may be utilized, whereby there is a series of images derived from the same scene (same original) but with dimensions reduced at each level of the pyramid. Thus, at a smallest resolution only macrofeatures may be present, while as the resolution up the pyramid increases finer details may be captured by the models. In some cases the pyramid may be intrinsic to the model, in others it may be algorithmically generated and used.

Explaining now training of the AI and ML models for the FRED marker detection module according to an exemplary embodiment. A training dataset may then be generated from a plurality of annotated images, in some embodiments a training sample may be comprised of a pair of a color image and black and white mask, the white being the foreground. In another embodiment the training images may contain a list of bounding boxes surrounding one or more reference markers (for example, 3). The training set may contain images with FRED and without FRED (no-FRED), which may be manually annotated. In an embodiment the training set may be further augmented with automatically annotated images, for example on simulated samples, a portion of which may FRED images and a portion of which may be no-FRED images. In an exemplary embodiment a training sample may be 64K images, further containing 43K simulated samples and 21K “real” images, or in another embodiment 360K images containing 104 k manually annotated and 256 k simulated and automatically annotated images.

A plurality of algorithms and models may be contemplated for use within the FRED marker detection module, for example a blob detection algorithm, a symmetry transformation algorithm, a dlib based algorithm, an HRNet algorithm, a Yolo algorithm, or a template matching algorithm. In some embodiments any of the AI/ML models may be customized and/or fully trained from scratch.

In some embodiments the perception pipeline module may further contain an eye glint sub-module. In a first sub-step a dedicated facial analysis model may locate a user's eyes and/or pupils. Within the detected area, in a second sub-step a glint detection model may detect a corneal glint, which may be understood to correspond to the front surface of the cornea or the corneal vertex. In some embodiments different models may be utilized based on the image detection methodology, for example a first glint model may correspond to images captured via a visible light flash, which a second glint model may correspond to a near infrared (NIR) flash. After isolating the iris region via any of the methods or ML models described, a dedicated ML model may infer a most probably position of the glint. The model may implement the detection as, for example, a bounding box detection.

Explaining now the training of the eye glint module, according to the specific embodiment a plurality of model sizes and input image resolutions may be utilized, for example 2M, 6M, or 9M sized models running at 200×200, 192×192, or 128×128 resolutions. In some embodiments the training dataset may include, for examples, a plurality (for example 28K) of iris image samples having a corresponding glint bounding box attached to them.

A plurality of algorithms and models may be contemplated for use within the eye glint module, for example a Viola Jones+blob detection algorithm, a geometrical model & Monte Carlo sampling algorithm, a particle filter algorithm, a MediaPipe+white blob detection algorithm, an HRNet algorithm, or a Yolo algorithm. In some embodiments any of the AI/ML models may be customized and/or fully trained from scratch.

The perception pipeline module may further contain a segmentation submodule. The segmentation module may determine the geometry of eyewear in order to compute the diameter and the relation between the eyewear and a user's face. In some embodiments an segmentation model may be used to determine the eyewear's frame and bounds detection. The input may be, for example, an image of an upper side of a user face. The segmentation model may further utilize mathematical analysis to refine the image, for example smoothen, align the left and right eyewears frames, and/or refine the eyewears position to match the user's facial contour. The segmentation module may further apply a geometric algorithm in order to fit a rectangle around the facial contour, the fitted rectangle may include a plurality of parameter's which may correspond to the eyewear's frames A-box (width), B-box (height), and/or a precise geometric center.

The segmentation module may be a variety of sizes and be trained with a variety of input image sizes. For example, in various embodiments the segmentation module may be 3.7M, 9M, 13.6M, 27M, or 64M, and the input image sizes may be 1024×512, 840×420, 640×320, or 448×224. The training data may comprise a mixed set of real and simulated images, for example 82K simulated images and 20K real images. In other embodiments any other number of images may be used.

A plurality of algorithms and models may be contemplated for use within the segmentation module, for example an edge-based CV algorithm, a Fourier descriptor based CV algorithm, a DL model or HRNet algorithm, a Yolo algorithm, and/or a DL model SegFormer algorithm. When generating the training images for the segmentation module a FRED mask may be separately stored, additionally a plurality of attributes associated with the eyewear may be recorded, for example family (rimless, semi-rimless, fullrim, sunglasses, etc), material (metal, plastic, etc), or shape (rectangle, oval, round, square, cateye, aviator, etc.).

Describing now in more detail the measurement module. It may be understood that after the steps described above a list of accurate 2D pixel coordinates corresponding to the FRED marker, the corneal glints, and the eyewear's frame features may have been obtained. The measurement module may be an ML model that takes as inputs the features described above, and calculates an eyewear's measurement using 3D geometry. The full list of parameters may include one or more of, for example, pupillary distance, fitting height (which may be understood to correspond to the 3D distance from a glint's coordinates to the bottom edge of the frame's B-box) vertex distance, wrap and pantoscopic angle (which may be derived from the 3D orientation of the FRED and/or be based on the 3D geometry of the person's head and eyewear).

According to an exemplary embodiment, a method for utilizing the automated system for taking eyewear measurements may include positioning a marking device on a eyewear frame worn by a user, the device including at least three predetermined reference points. A next step may include capturing a plurality of images of the eyewear wearer using an image capture device and automatically analyzing each captured image using artificial intelligence (AI) to identify and locate the reference points, corneal reflections, and frame contours. The marking device may be removable and reusable on different eyewear frames, and the reference points may be physically marked, luminous, infrared, or virtual.

A next step may include automatically calculating, from the extracted data, selected eyewear measurements including interpupillary distances, pupillary heights, pantoscopic tilt, vertex distance, reading distance, and frame curvature. A next step may include subjecting the calculated eyewear measurements to statistical analysis, including but not limited to calculating the median, mean, mode, or other statistical values based on data extracted from the plurality of captured images. The calculation of eyewear measurements may include adjustments to compensate for any distortion or optical aberration caused by the lens of the camera used to capture the images.

In at least some embodiments the eyewear measurements may be automatically adjusted based on variations in the position and orientation of the image capture device relative to the wearer's face.

In some embodiments the measurement module may automatically calculate all the necessary measurements (interpupillary distances, pupillary heights, pantoscopic tilt, etc.) based on the extracted data. The artificial intelligence may operate in real-time, allowing for immediate visualization and instant adjustment of the eyewear measurements during the measurement process. The AI modules may then be used in analyzing the raw data (images of subjects, their movement behavior, etc). Once the AI models have analyzed and extracted information from images this information may be used to mathematically compute the measurements (distances taking depth or not, angles, etc). It may be understood that the AI may obtain very precise image coordinates of user, FRED and facial features for use in the calculations. These image coordinates may then mapped into real 3D space using, for example, either stereoscopy or stereoscopy combined with depth sensing (where available). The final calculations may involve spatial geometry computations in a 3D space of the real world where all points are mapped.

In some embodiments the eyewear measurements may be used for additional applications including, but not limited to, adjusting corrective lenses, custom manufacturing of frames, or any other application requiring precise measurement of the dimensions and geometry of an object worn on the human face.

It may be understood the above system and method may, for example, address the shortage of qualified opticians by enabling accurate measurements without the need for specialized training, and reduce the likelihood of human error and ensure consistent quality through the use of automation. In some embodiments by obtaining multiple images and applying statistical analysis, the system may achieve high precision in the eyewear measurements, reducing the need for adaptation, especially for progressive lenses. It may be understood that in some embodiments the system may handle a large number of images allowing for adaptability for both individual fittings and large-scale operations.

In some embodiments further ML models may be applied to the above steps and methods in order to increase accuracy. For example, a skin tone classification module which may extract color histograms in various color spaces on representative facial sliding patches and combine them in a feature vector thereby reducing the dimensionality of the feature vector using Principal Component Analysis and then apply a Support Vector Machine to determine the skin tone.

A Hair color analysis module that uses a CNN (U-Net) to segment the facial image pixels into hair, face and background classes and determines hair color using a Random Forest Classifier based on features extracted at super-pixel level. A race or ethnicity model which may help distinguish or correct for differences in race or ethnicity of users. A face shape analysis module which may use a U-Net architecture for extract a contour of the face and define a rule-based system for face shape analysis based on different proportions of the face.

A hair segmentation module which may use a U-net in order to segment hair from the image. An age-gender analysis module, and age estimation module, a gender estimation module, and/or a pose estimation module. Each of the modules may use a plurality of different models or algorithms, for example color-based CV algorithm, CNN model, CNN+ANN model, CNN+rule-based model, multi-task CNN, regression based CNN, or face-alignment CNN.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for determining eyewear measurements using a frame reference device (FRED) having been placed on an eyewear frame of a user, wherein the FRED includes one or more known frame marker distances, the method comprising:
obtaining one or more images of the FRED on the eyewear frame of the user by an image capturing device;
determining, via one or more machine learning (ML) models, a plurality of data points from the one or more obtained images; and
generating, based on the plurality of data points and the one or more known frame marker distances, eyewear measurements.

2. The method of claim 1, wherein the one or more machine learning models comprises:
a FRED marker model configured to detect one or more FRED markers from the one or more obtained images;
a corneal glint model configured to detect (1) pupils of the user from the one or more obtained images and (2) a corneal vertex on the obtained images; and
a FRED segmentation model configured to determine a geometry and bounds of the eyewear frame and determine a relation between the eyewear frame and a face of the user.

3. The method of claim 2, wherein the plurality of data points from the one or more obtained images include one or more of a pupillary distance, a fitting height, a vertex distance, a wrap, and pantoscopic angle.

4. The method of claim 2, further comprising creating a training dataset; and
training the one or more machine learning models on a training dataset;
wherein the creating the training dataset comprises (1) annotating a plurality of training images with a plurality of reference markers each corresponding to a FRED marker and (2) creating a white and black mask of the training image or generating a bounding box around the plurality of reference markers.

5. The method of claim 4, wherein the creating the training dataset further comprises generating a plurality of simulated images.

6. The method of claim 4, wherein the FRED marker model is one of a blob detection algorithm, Symmetry transformation algorithm, dlib algorithm, HRNet algorithm, Yolo Algorithm, or template matching algorithm.

7. The method of claim 1, wherein the image capturing device includes one of a pair of stereo cameras or a camera and a LIDAR; and
the image capturing device is configured to capture the image with one of a visible light flash or a near infrared (NIR) flash.

8. A computer program product for determining eyewear measurements comprising:
a non-transitory computer-readable medium; and
computer instructions, embedded in the non-transitory computer-readable medium, for controlling a processor when executing the computer instructions to perform the steps of:
obtaining one or more images of a frame reference device (FRED) including one or more known frame marker distances on an eyewear frame of a user by an image capturing device;
determining, via one or more machine learning (ML) models, a plurality of data points from the one or more obtained images; and
generating, based on the plurality of data points and the one or more known frame marker distances, eyewear measurements.

9. The computer program product of claim 8, wherein the one or more machine learning models comprises:
a FRED marker model configured to detect one or more FRED markers from the one or more obtained images;
a corneal glint model configured to detect (1) pupils of the user from the one or more obtained images and (2) a corneal vertex on the obtained images; and
a FRED segmentation model configured to determine a geometry and bounds of the eyewear frame and determine a relation between the eyewear frame and a face of the user.

10. The computer program product of claim 9, wherein the plurality of data points from the one or more obtained images include one or more of a pupillary distance, a fitting height, a vertex distance, a wrap, and pantoscopic angle.

11. The computer program product of claim 9, wherein the computer instructions further comprise creating a training dataset; and
training the one or more machine learning models on a training dataset;
wherein the creating training dataset comprises (1) annotating a plurality of training images with a plurality of reference markers each corresponding to a FRED marker and (2) creating a white and black mask of the training image or generating a bounding box around the plurality of reference markers.

12. The computer program product of claim 11, wherein the creating the training dataset further comprises generating a plurality of simulated images.

13. The computer program product of claim 11, wherein the FRED marker model is one of a blob detection algorithm, Symmetry transformation algorithm, dlib algorithm, HRNet algorithm, Yolo Algorithm, or template matching algorithm.

14. The computer program product of claim 8, wherein the image capturing device includes one of a pair of stereo cameras or a camera and a LIDAR; and
the image capturing device is configured to capture the image with one of a visible light flash or a near infrared (NIR) flash.

15. A system for determining eyewear measurements using a frame reference device (FRED) including one or more known frame marker differences configured to be placed on an eyewear frame of a user, the system comprising;
an image capture device configured to obtain one or more images of the FRED having been placed on the eyewear frame of the user;
a perception pipeline module containing one or more machine learning (ML) models configured to determine a plurality of data points from the one or more obtained images; and
a measurement module configured to, based on the plurality of data points and the one or more known frame marker distances, generate eyewear measurements.

16. The system of claim 15, wherein the perception pipeline module further comprises:
a FRED marker model configured to detect one or more FRED markers on the one or more obtained images;
a corneal glint model configured to detect (1) pupils of the user from the one or more obtained images and (2) a corneal vertex on the obtained images; and
a FRED segmentation model configured to determine a geometry and bounds of the eyewear frame and determine a relation between the eyewear frame and a face of the user.

17. The system of claim 16, wherein the plurality of data points from the one or more obtained images include one or more of a pupillary distance, a fitting height, a vertex distance, a wrap, and pantoscopic angle.

18. The system of claim 16, wherein the FRED marker model is trained via a generated training dataset; and
the training dataset is generated by (1) annotating a plurality of training images with a plurality of reference markers each corresponding to a FRED marker and (2) creating a white and black mask of the training image or generating a bounding box around the plurality of reference markers.

19. The system of claim 15, wherein the FRED marker model is one of a blob detection algorithm, Symmetry transformation algorithm, dlib algorithm, HRNet algorithm, Yolo Algorithm, or template matching algorithm.

20. The system of claim 15, wherein the image capturing device includes one of a pair of stereo cameras or a camera and a LIDAR.
